(19) United States
(12) Patent Application Publication
(10) Pub. No.: US 2015/0199683 A1
(43) Pub. Date: Jul. 16, 2015

(54) ONLINE SHOPPING SYSTEM AND METHOD WITH CASH

(71) Applicant: Corbuss Kurumsal Telekom Servis Hizmetleri Anonim Sirketi, Istanbul (TR)

(72) Inventor: Kadir Semih Incedayi, Istanbul (TR)

(73) Assignee: Global Ödeme Sistemleri Anonim Sirketi, Istanbul (TR)

(21) Appl. No.: 14/495,902

(22) Filed: Sep. 25, 2014

(30) Foreign Application Priority Data
Sep. 25, 2013 (TR) 2013/11245

(51) Int. Cl. G06Q 20/38

(52) U.S. Cl. CPC G06Q 20/382; G06Q 40/02

(57) ABSTRACT

The present invention relates to a system and method which enables to shop online securely by paying with cash without using any credit/bank/pre-paid bank card. The present invention comprises at least one member business selling products or service over the internet, at least one agent adapted to enable the customers to shop securely from member businesses by using, cash and which is registered to the system via a bank or credit card, at least one user interface enabling the customer information to be entered to the system, at least one bank server adapted to create a single use virtual prepaid card, transfer the balance as much as the amount of the transaction which is subtracted from the bank or credit card of the agent to the single use virtual prepaid card, transmit the customer information and the single use prepaid bank card number to the member business.

### FIELD OF THE INVENTION

The present invention relates to a secure shopping system and method which enables to shop online securely by paying with cash without using any credit/bank/pre-paid bank card.

### BACKGROUND OF THE INVENTION

As the internet has become more common, the consumers prefer online shopping performed through electronic payment media such as interact, phone, fax etc. instead of purchasing the products they want from the shops. Credit cards are used in online shopping instead of cash. Some sellers store the credit card information of the customers in online shopping, and withdraw money from the card without the customer's confirmation, for this reason the consumers are abused.

Another problem is that some part of the tourists going to another country for business, vacation or other reasons has prepaid GSM lines and they want to load their GSM lines in these countries they go. However, the channels and methods for this are limited. Especially, loading becomes more difficult for the ones who do not have internet access, who do not want to give their credit card information for security issues or who have difficulty in using internet.

A further problem is the scratch game cars which are sold in gaming sector and have costs of production and distribution, and the e-pin sales in interne cafes developed for shopping without card. Online gaming sector is developing each year and many companies enter into this market. However, an important part of the users playing online games is under 18 years old; therefore these users do not have credit cards. There is an electronic pin (e-pin) application developed for these users in order to avoid this problem. The methods for buying e-pin are limited. Again, in these applications, the said e-pins that can be sold without making out an invoice cannot be recorded.

United States Patent Document no U.S. Pat. No. 5,825,881, an application known in the state of the art, discloses system for conducting commerce between a Merchant and a customer over the Internet. The customer chooses a product from the web site of the merchant, and the shopping is performed by sending the credit card information of the customer to the merchant.

International Patent Document no WO0111515, an application known in the state of the art, discloses a system which enables to make electronic payment over the interne in anonymity and security. Pre-paid stored value card (“cash card”) including a cash card identification number for a predetermined amount of money may be purchased at a point of sale. A user enters to the web site of the merchant, chooses a product, and enters the cash card identification number and the Personal Security Code to transmit for confirmation to the server. Then the server of the merchant's web site subtracts the cost of the item from the predetermined amount on the cash card of the user and thus shopping is completed.

International Patent Document no WO2006011019, an application known in the state of the art, discloses a voucher' based payment system is provided for services that are delivered by way of prepayment meters of the type requiring tokens to be inputted from time to time. The tokens reached with the said payment system are of a type that can be transmitted by wireless or landline communication means. The payment system comprises a plurality of voucher vendors each of which is enabled to sell to consumers' vouchers that each has a predetermined or consumer selected value and a voucher identifier.

### SUMMARY OF THE INVENTION

In the embodiments known in the state of the art, a special collection system is established between the company selling the product and the distributor, whereas in this invention current virtual POS (Point of Sale) system is used. A one-time virtual prepaid card is formed specific for the transaction being made and thus extra security is provided. Then the said virtual prepaid card information (open to global payment systems such as Mastercard/Visa) is transmitted to the virtual POS, provision is received from the card of the agent by the said system, the amount is withdrawn from the current card of the agent (debit/credit card) as a result of the transaction. In another method used in this invention, the amount of the purchase is directly withdrawn from the agent's bank or credit card by the said system without creating a single use prepaid card by recording the card of the agent to the system.

The objective of the present invention is to provide an online shopping system and method which enables the individuals to reach the products to be purchased online by paying cash to the physical shops, kiosk, ATM or agencies such as staff at physical shops via the said agents.

Another objective of the present invention is to provide an online shopping system and method which enables to create a single time virtual prepaid card specific for each transaction and transmitting this virtual prepaid card information to the virtual POS of the member business in order to carry out a secure transaction. On the other hand, the system can work securely without creating a single time prepaid card. The cards of the registered agents are stored securely in areas with special certificates, and the card number can be transmitted to the virtual POS of the member business by the system without displaying on any screen during transaction.

### DETAILED DESCRIPTION OF THE INVENTION

An online shopping system and method developed to fulfill the objective of the present invention is illustrated in the accompanying figures, in which,

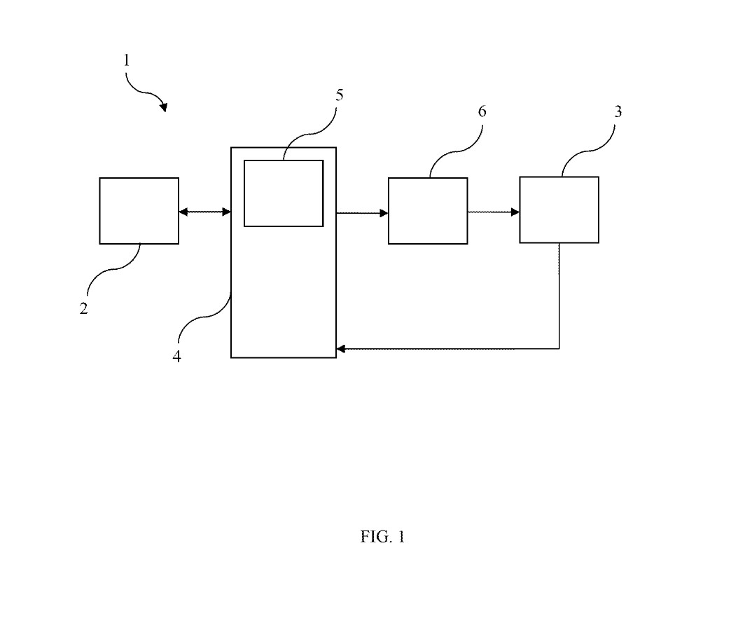

FIG. 1 is the schematic view of the online shopping system.

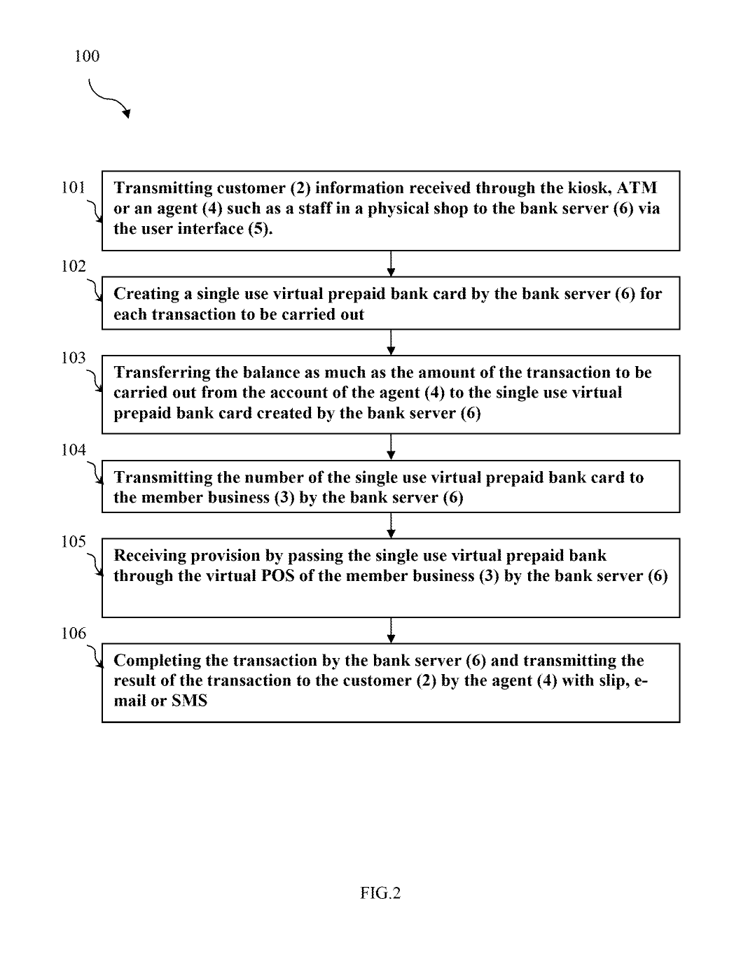

FIG. 2 is the steps of the online shopping method.

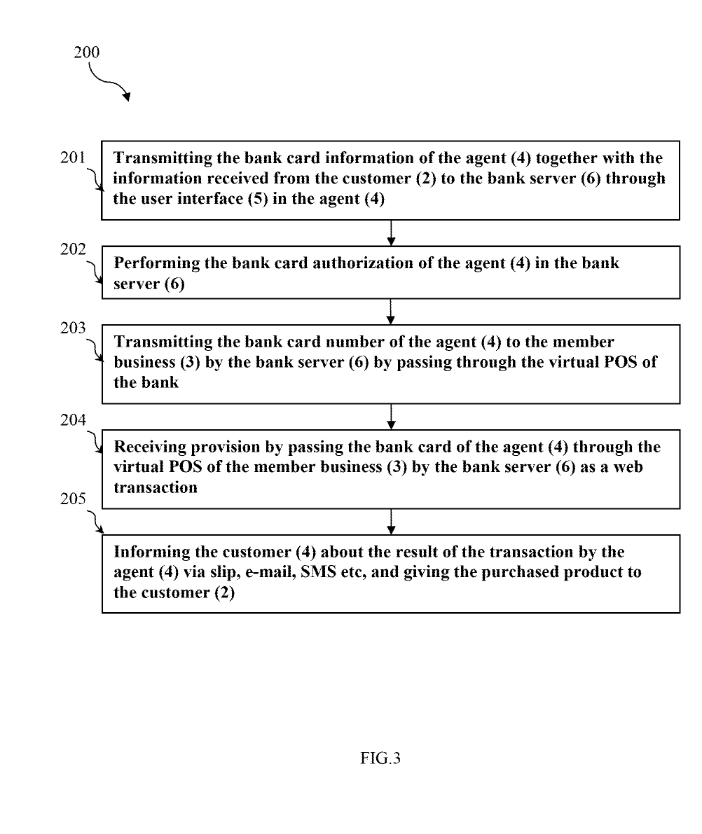

FIG. 3 is the steps of an alternative online shopping method.

The components shown in the figures are each given reference numbers as follows:

1. Online shopping system

2. Customer

3. Member business

4. Agent

5. User interface

6. Bank server

100. Online shopping method

200. Alternative online shopping method

An online shopping system (1), which enables to shop online securely by paying with cash without using any credit/bank/pre-paid bank card, essentially comprises the steps of
at least one customer (2).
at least one member business (3) which sells products or service over the internet,
at least one agent (4) which is adapted to enable the customers (2) to shop securely from member businesses (3) by using cash and which is preferably a kiosk or ATM or a staff present in physical shops, registered to the system via a bank or credit card,
at least one user interface (5) which enables the customer (2) information to be entered to the system through kiosk, ATM or by a staff in a physical shop through a device provided to the said staff, and which has internet access,
at least one bank server (6) which is adapted to create a single use virtual prepaid card as the amount of the transaction specific for each transaction, transfer the balance as much as the amount of the transaction which is subtracted from the bank or credit card of the agent (4) to the single use virtual prepaid card, transmit the customer (2) information entered over the user interface (5) and the single use prepaid bank card number to the member business (3).

The inventive online shopping system (1) is a system enabling online shopping without the customer (2) having, any credit/bank/prepaid bank card. Some of the main fields of use are shopping from the sites selling products or services online, charging the international GSM line and purchasing e-in in gaming sector. Since the purchase transactions are carried out by passing through the virtual POS of the member business (3) making e-commerce (electronic commerce), it is easy to develop and generalize the application. Virtual POS represents the POS (Point of Sale) devices and systems used in conventional shopping which is adapted for internet, that is which allows to shop through the web sites.

The transactions in the online shopping system (1) are carried out through the agents (4) registered to the said system. The agents can also be in alternative places such as kiosk, ATM stands etc. as well as they can be a staff in physical shops. The said agents (4) have interne connection and the agents (4) should have bank or credit cards in order to register to the system. The agents (4) have an account opened through the contracted bank and have a bank card or credit card. The agents (4) provide the necessary information such as card no, name-surname, address etc to the institution or the individual operating the online shopping system (1), they are registered to the said system which will be developed with the bank or credit card that they have provided before. Card no and other information of the agents (4) are stored in a secure environment (compatible with PCI-DSS), bank server (6). The agents (4) put money to their account for carrying out transactions or there is a credit card limit of the agents (4).

Online shopping method (100) essentially comprises the steps of
transmitting customer (2) information received through the kiosk, ATM or an agent (4) such as a staff in a physical shop to the hank server (6) via the user interface (5) (101),
creating a single use virtual prepaid bank card by the bank server (6) for each transaction to be carried out (102),
transferring the balance as much as the amount of the transaction to be carried out from the account of the agent (4) to the single use virtual prepaid bank card created by the bank server (6) (103),
transmitting the number of the single use virtual prepaid bank card to the member business (3) by the bank server (6) (104).
receiving provision by passing the single use virtual prepaid bank through the virtual POS of the member business (3) by the bank server (6) (105),
completing the transaction by the bank server (6) and transmitting the result of the transaction to the customer (2) by the agent (4) with slip, e-mail or SMS (106).

In a preferred embodiment of the invention, the customer (2) comes to an agent (4) registered to the system and states the amount of the transaction which they want to perform and the member business (3). If the agent (4) is a staff in physical shops, the said staff performs the transactions through a device provided to them having, internet connection and user interface (5). Additional information may be wanted from the customer (2) depending on the type of the transaction. For example, if international GSM line is wanted to be loaded, information such as name-surname, address, mobile number of the customer (2), name of the GSM operator to which they are subscribed, the amount to be loaded to the phone line etc. can be wanted from the customer (2). When the customer (2) wants to carry out a transaction, the agent (4) enters the necessary information they receive from the customer (2) to the system through a secure user interface (5) such as POS. Web interface etc. opened from themselves (101).

In one embodiment of the invention, the customer (2) enters the required information to the agents (4) such as a device, kiosk, ATM etc having internet connection.

After the necessary information are entered into the system, these information are transmitted to the bank server (6) and a single use virtual prepaid bank card specific for the transaction that is being made is created by the bank server (6) (102). A balance as much as the amount of the transaction to be made is transferred from the hank or credit card of the agent (4) registered to the system to the single use virtual prepaid bank card by the bank server (6) (103). The information received from the customer (2) and entered through the user interface (5) and the single use virtual prepaid card number are transmitted to the member business (3) by the bank server (6) (104). The information transmitted to the member business (3) passes like a normal web shopping transaction through the virtual POS of the member business (3), and the provision is received from the said virtual POS (105).

In one embodiment of the invention, in case POS device is used as user interface (5), the result of the transaction (e-pin or the confirmation) is transferred to the customer (2) via a slip coming out of the POS (106). Therefore, the member business (3) carries out the service/product sale.

In another embodiment of the invention, in case Web interface is used as the user interface (5) instead of POS device, the result of the transaction is transferred to the customer (2) via SMS or electronic mail.

An invoice is issued in name of the customer (2) by the member business (3), the amount og the transaction transferred to the single use virtual prepaid card specific to the transaction being made is provided from the customer (2) in cash. In another embodiment of the invention, the amount of the transaction can be collected from the customer (2) by the agent (4) via payment means such as credit card, prepaid card etc. instead of cash. For foreign currency such as Dollar, Euro and the like, these currencies are converted into the desired currency by the system and the agent (4) collects the amount from the customer (2).

In one embodiment of the invention, the system can operate securely without creating a single use prepaid card. The cards of the registered agents (4) are stored securely in areas with special certificates, and the card number can be transmitted to the virtual POS of the member business (3) by the system in the background without displaying on any screen during transaction.

An alternative online shopping method (200), which is carried out without creating single use prepaid card, comprises the steps of
transmitting the bank card information of the agent (4) together with the information received from the customer (2) to the bank server (6) through the user interface (5) in the agent (4) (201),
performing the bank card authorization of the agent (4) in the bank server (6) (201),
transmitting the bank card number of the agent (4) to the member business (3) by the bank server (6) by passing through the virtual POS of the bank (203),
receiving provision by passing the bank card of the agent (4) through the virtual POS of the member business (3) by the bank server (6) as a web transaction (204),
informing the customer (4) about the result of the transaction by the agent (4) via slip, e-mail, SMS etc, and giving the purchased product to the customer (2) (205).

In another preferred embodiment of the invention, the customer (2) comes to an agent (4) registered to the system and states the amount of the transaction which they want to perform and the member business (3). The agent (4) enters the required information they receive from the customer (2) (for example, information such as name-surname of the customer (2), address, mobile number, the name of the GSM operator to which they are subscribed, amount to be loaded to the phone line, etc) over a secure user interface (5) such as POS. Web interface etc opened for themselves. After the necessary information are entered to the system, the bank card information of the agent (4) together with the said information are transmitted to the bank server (6) over the user interface (5) (201) and the card authorization of the bank card of the agent (4) is performed in the bank server (6) (202). Then the bank card number of the agent (4) is passed through the virtual POS of the bank as a web transaction and transmitted to the member business (3) (203). The bank card of the agent (4) transmitted to the member business (3) is passed through the virtual POS of the member business (3) and the provision is received (204).

In one embodiment of the invention, in case POS device is used as user interface (5), the result of the transaction (e-pin or the confirmation) is transferred to the customer (2) via a slip coming out of the POS. In case Web interface is used as user interface (5), the result of the transaction is transmitted to the customer (2) via SMS or electronic mail, then the product purchased by the customer (2) is transferred to the customer (2) by the agent (4) (205). The result of the said shopping transaction performed over the agent (4) can be queried by the agent (4) by entering into the user interface (5).

1. An online shopping system (1), which enables to shop online securely by paying with cash without using any credit/bank/pre-paid bank card, essentially comprising
at least one member business (3) which sells products or service over the internet,
and characterized by
at least one agent (4) which is adapted to enable the customers (2) to shop securely from member businesses (3) by using cash and which is preferably a kiosk or ATM or a staff present in physical shops, registered. to the system via a bank or credit card,
at least one user interface (5) which enables the customer (2) information. to be entered to the system through kiosk, ATM or by a staff in a physical shop through a device provided to the said staff, and which has internet access,
at least one bank server (6) which is adapted to create a single use virtual prepaid card as the amount of the transaction specific for each transaction, transfer the balance as much as the amount of the transaction which is subtracted from the bank or credit card of the agent (4) to the single use virtual prepaid card, transmit the customer (2) information entered over the user interface (5) and the single use prepaid bank card number to the member business (3).

2. An online shopping system (1) according to claim 1, characterized by bank server (6) which is adapted to store the credit card and subscription information of the agents (4).

3. An online shopping system (1) according to clam 1, characterized by user interface (5) which is adapted to transmit the information received from the customer (2) to the bank server (6) over the internet.

4. An online shopping method (1), which enables to shop online securely by paying with cash without using any credit/bank/pre-paid bank card, essentially characterized by the steps of
transmitting customer (2) information received through the kiosk, ATM or an agent (4) such as a staff in a physical shop to the bank server (6) via the user interface (5) (101),
creating a single use virtual prepaid bank card by the hank server (6) for each transaction to be carried out (102),
transferring the balance as much as the amount of the transaction to be carried out from the account of the agent (4) to the single use virtual prepaid bank card created by the bank server (6) (103),
Transmitting the number of the single use virtual prepaid bank card created to the member business (3) by the bank server (6) (104),
receiving provision by passing the single use virtual prepaid bank number through the virtual POS of the member business (3) by the bank server (6) (105),
completing the transaction by the bank server (6) and transmitting the result of the transaction to the customer (2) by the agent (4) with slip, e-mail or SMS (106).

5. An online shopping method (100) according to claim 4, characterized by the step (101) wherein customer (2) information such as name-surname of the user, address, mobile number, the name of the GSM operator to which they are subscribed, amount to be loaded to the phone line, etc received through the kiosk, ATM or an agent (4) such as a staff in a physical shop are transmitted to the bank server (6) via the user interface (5)
